(19) United States
(12) Patent Application Publication
(10) Pub. No.: US 2009/0002279 A1
(43) Pub. Date: Jan. 1, 2009

(54) Plasma display device and control method thereof

(75) Inventor: Masanori Takeuchi, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY, Kanagawa (JP)

(21) Appl. No.: 12/222,800

(22) Filed: Aug. 15, 2008

Related U.S. Application Data
(63) Continuation of application No. 11/297,638, filed on Dec. 9, 2005.

(30) Foreign Application Priority Data
Dec. 10, 2004 (JP) 2004-358502

(51) Int. Cl. G09G 3/28

(52) U.S. Cl. 345/63

(57) ABSTRACT

A plasma display device is provided which expresses a video with gradations by selecting each of a plurality of subfields forming one field, each of the subfields having a weighted number of sustain pulses. A sustain pulse number calculation unit calculates a display load factor of an input video signal and calculates a total number of sustain pulses of one field according to the display load factor. A gradation number selection unit selects a gradation number being a sum of weights of all of the subfields according to the calculated total number of sustain pulses.

### CROSS-REFERENCE TO RELATED APPLICATIONS

This application is a continuation of U.S. application Ser. No. 11/297,638, filed Dec. 9, 2005, claiming the benefit of priority from prior Japanese Patent Application No. 2004-358502, filed Dec. 10, 2004, the entire contents of which are incorporated herein by reference.

### BACKGROUND OF THE INVENTION

1. Field of the Invention

The present invention relates to a plasma display device and a control method thereof.

2. Description of the Related Art

A plasma display device conducts the power constant control, in which the number of sustain pulses that the plasma display device can emit is determined according to the display load factor. Besides, the actual number of gradations of the plasma display device is determined by the sum of weights of all of subfields which is not dependent on the display load factor. Therefore, in a video with a smaller display load factor, that is, a darker video, the total number of sustain pulses is larger, leading to a larger number of emitted sustain pulses per gradation. On the other hand, in a video with a larger display load factor, that is, a brighter video, the total number of sustain pulses is smaller, leading to a smaller number of emitted sustain pulses per gradation. In particular, a subfield with the smallest weight is used for an error diffusion processing bits in which the luminance of the error diffusion bits varies depending on a video scene which is recognized as flicker. On the other hand, the dark video with a smaller display load factor has suffered from insufficient expressiveness at a lower gradation value part. This is because a dark video has a larger difference between gradation values than that of a bright video.

In Patent Reference 1 described later, the peak luminance in one field is changed according to the average luminance level (APL) of video data. However, the APL does not always match with the number of sustain pulses when the following controls are performed: control of the amount of power supplied; control of the number of sustain pulses according to the display load factor of each subfield to improve the peak luminance; and control to reduce the number of sustain pulses to keep heat of a plasma display panel and circuit components and so on at a fixed temperature or lower, and so on. Therefore, a non-negligible difference may appear between the number of gradations and the number of sustain pulses which can be inputted. For example, when the number of sustain pulses is too large with respect to the number of gradations, the number of sustain pulses to be allocated to the minimum subfield is not constant, causing diffusion error and flicker (occurring due to variation in luminance of the minimum subfield) at the lower gradation value part. For example, where the number of gradations is 256, when the number of sustain pulses which can be inputted is 1000, the number of sustain pulses to be allocated to the minimum subfield is four, while when the number of sustain pulses which can be inputted is 768, the number of sustain pulses to be allocated to the minimum subfield is three. The number of sustain pulses which can be inputted varies depending on a video, with which the number of sustain pulses to be allocated to the minimum subfield also varies. Conversely, when the number of sustain pulses is too small with respect to the number of gradations, the ratio at which the numbers of sustain pulses to be allocated to subfields is different from the luminance ratio represented by the subfield array, resulting in an image with insufficient gradations. This occurs particularly in a subfield with a smaller weight, so that noise occurs in a contour form at a lower gradation value part of a video.

(Patent Document 1)

Japanese Patent Application Laid-open No. 2003-29704

### SUMMARY OF THE INVENTION

An object of the present invention is to provide a plasma display device which can select the number of gradations suitable for the number of sustain pulses varying according to the display load factor and a control method thereof.

According to one aspect of the present invention, a plasma display device is provided which expresses a video with gradations by selecting each of a plurality of subfields forming one field, each of the subfields having a weighted number of sustain pulses. A sustain pulse number calculation unit calculates a display load factor of an input video signal and calculates a total number of sustain pulses of one field according to the display load factor. A gradation number selection unit selects a gradation number being a sum of weights of all of the subfields according to the calculated total number of sustain pulses.

### BRIEF DESCRIPTION OF THE DRAWINGS

FIG. 1 is a diagram showing a configuration example of a plasma display device according to a first embodiment of the present invention;

FIGS. 2A to 2C are views each showing an example of a sectional configuration of a display cell;

FIG. 3 is a diagram of a configuration example of one field of a video;

FIG. 4 is a list showing weighting of each of subfields of six gradation numbers;

FIG. 5 is a list showing the relation between selection patterns of the subfields of a 512-gradation and output gradation values;

FIG. 6 is a list showing the relation between selection patterns of the subfields of a 448-gradation and output gradation values;

FIG. 7 is a list showing the relation between selection patterns of the subfields of a 384-gradation and output gradation values;

FIG. 8 is a list showing the relation between selection patterns of the subfields of a 320-gradation and output gradation values;

FIG. 9 is a list showing the relation between selection patterns of the subfields of a 256-gradation and output gradation values;

FIG. 10 is a list showing the relation between selection patterns of the subfields of a 192-gradation and output gradation values;

FIG. 11 is a graph showing the relation between the display load factor and the total number of sustain pulses;

FIG. 12 is a graph for explaining processing of a nonlinear gain control processing unit;

FIG. 13 is a diagram showing a configuration example of the nonlinear gain control processing unit and an error diffusion processing unit;

FIG. 14 is a list showing an example where the error diffusion processing unit generates gradation values by error diffusion; and

FIG. 15 is a diagram showing a configuration example of a plasma display device according to a second embodiment of the present invention.

### DETAILED DESCRIPTION OF THE PREFERRED EMBODIMENTS

### First Embodiment

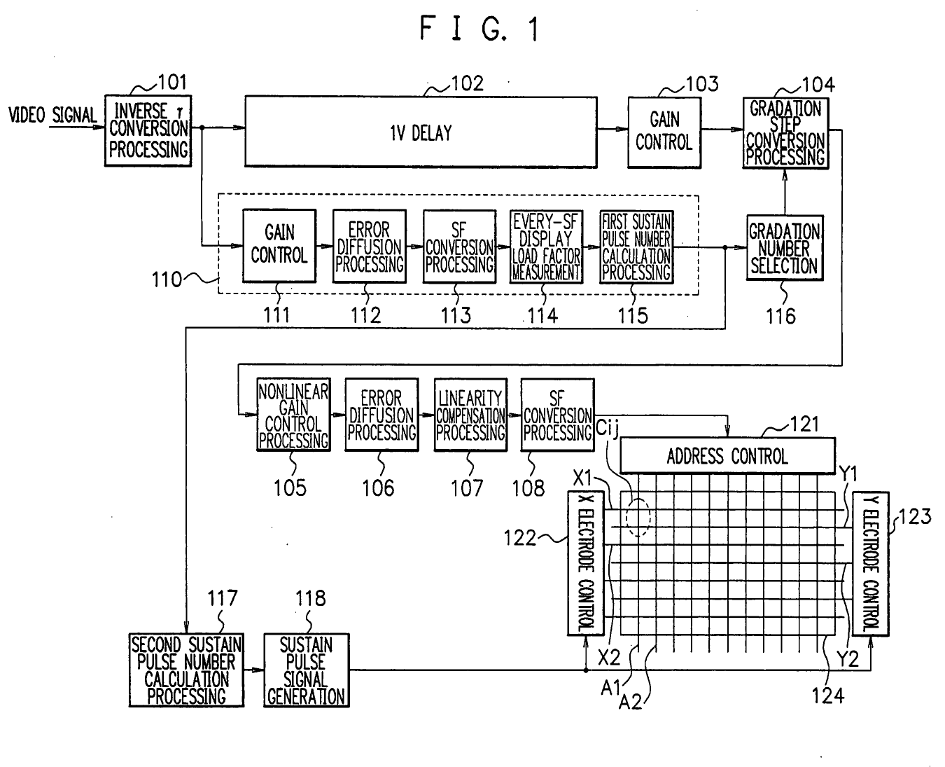

FIG. 1 is a diagram showing a configuration example of a plasma display device according to a first embodiment of the present invention. An address control unit 121 supplies a predetermined voltage to address electrodes A1, A2, and so on. Hereinafter, each of the address electrodes A1, A2, and so on or their generic name is an address electrode Aj, j representing a suffix.

A Y electrode control unit 123 supplies a predetermined voltage to Y electrodes Y1, Y2, and so on. Hereinafter, each of the Y electrodes Y1, Y2, and so on or their generic name is a Y electrode Yi, i representing a suffix.

An X electrode control unit 122 supplies a predetermined voltage to X electrodes X1, X2, and so on. Hereinafter, each of the X electrodes X1, X2, and so on or their generic name is an X electrode Xi, i representing a suffix.

Within a display region 124, the Y electrodes Yi and the X electrodes Xi form rows extending in parallel in the horizontal direction, and the address electrodes Aj form columns extending in the vertical direction. The Y electrodes Yi and the X electrodes Xi are arranged alternately in the vertical direction.

The Y electrodes Yi and the address electrodes Aj form a two-dimensional matrix with i rows and j columns. A display cell Cij is formed of an intersection of the Y electrode Yi and the address electrode Aj and the X electrode Xi correspondingly adjacent thereto. This display cell Cij corresponds to a pixel, so that the display region 124 can display a two-dimensional image. The X electrode Xi and the Y electrode Yi within display cell Cij have a space therebetween to form a capacitive load.

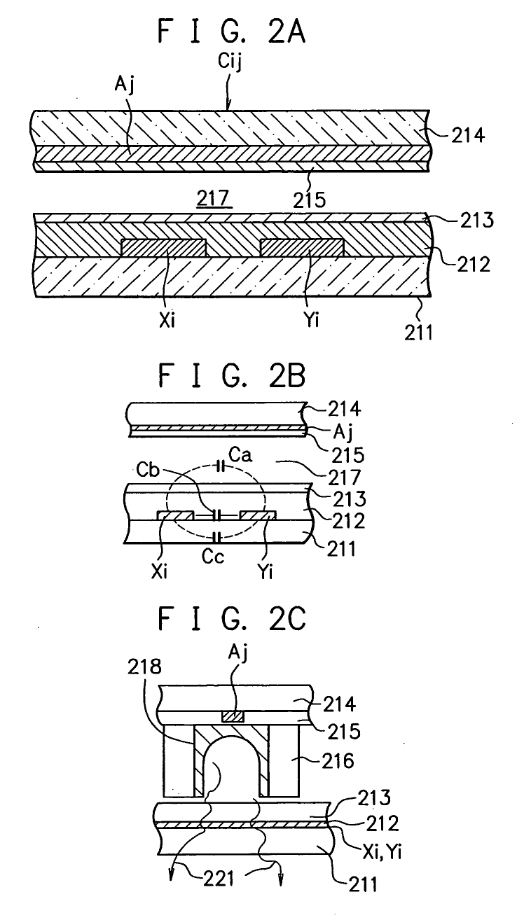

FIG. 2A is a view showing an example of a sectional configuration of the display cell Cij in FIG. 1. The X electrode Xi and the Y electrode Yi are formed on a front glass substrate 211. A dielectric layer 212 for insulating them from a discharge space 217 is deposited on them, and a MgO (magnesium oxide) protective film 213 is further deposited on the dielectric layer 212.

On the other hand, the address electrode Aj is formed on a rear glass substrate 214 which is disposed to oppose the front glass substrate 211, a dielectric layer 215 is deposited thereon, and further phosphors are deposited on the dielectric layer 215. In the discharge space 217 between the MgO protective film 213 and the dielectric layer 215, a Ne+Xe Penning gas or the like is sealed.

FIG. 2B is a view for explaining a panel capacitance Cp of an AC drive type plasma display. A capacitance Ca is a capacitance of the discharge space 217 between the X electrode Xi and the Y electrode Yi. A capacitance Cb is a capacitance of the dielectric layer 212 between the X electrode Xi and the Y electrode Yi. A capacitance Cc is a capacitance of the front glass substrate 211 between the X electrode Xi and the Y electrode Yi. The sum of the capacitances Ca, Cb, and Cc determines the panel capacitance Cp between the electrodes Xi and Yi.

FIG. 2C is a view for explaining light emission of the AC drive type plasma display. On an inner surface of a rib 216, phosphors 218 in red, blue and green are applied, arranged in stripes for each color, so that a discharge between the X electrode Xi and the Y electrode Yi excites the phosphors 218 to generate light 221.

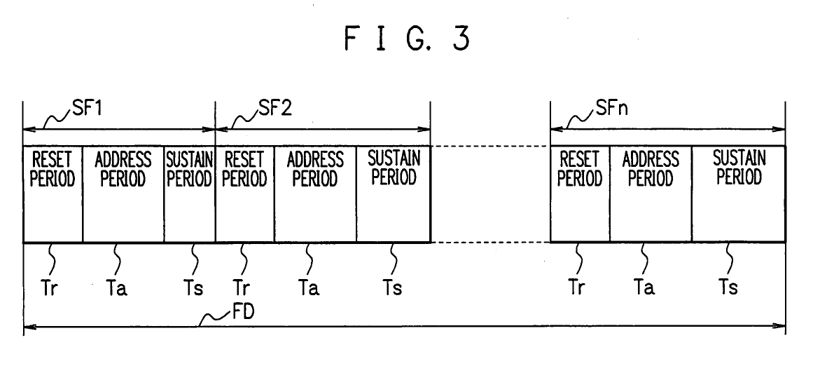

FIG. 3 is a diagram of a configuration example of one field FD of a video. The video is formed of, for example, 60 fields per second. One field FD is formed of a first subfield SF1, a second subfield SF2, . . . , and an nth subfield SFn. This n is, for example, 10, and corresponds to the number of gradation bits. Each of the subfields SF1, SF2, and so on or their generic name is a subfield SF hereinafter.

Each subfield SF is composed of a reset period Tr, an address period Ta, and a sustain period (sustain discharge) period Ts. During the reset period Tr, the display cell is initialized. During the address period Ta, emission or non-emission of each display cell can be selected by address discharge between the address electrode Aj and the Y electrode Yi. During the sustain period Ts, sustain discharge is performed between the X electrode Xi and the Y electrode Yi of the selected display cell to emit light. The number of light emission times (the duration of the sustain period Ts) by sustain pulses between the X electrode Xi and the Y electrode Yi is different in each subfield SF. This can determine a gradation value.

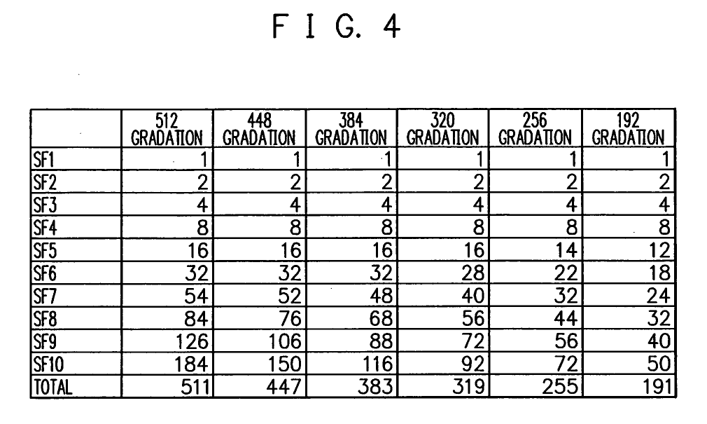

FIG. 4 shows a list showing weighting of each of subfields SF1 to SF10 of six gradation numbers. In this embodiment, according to the total number of sustain pulses in one field, one gradation number is selected from among the six gradation numbers. Although the number of selectable gradation numbers is not limited to six, the case of six will be described herein. One field is composed of, for example, 10 subfields. Each of the subfields SF1 to SF10 has the weighted number of sustain pulses. These six gradation numbers are, for example, 512-gradation, 448-gradation, 384-gradation, 320-gradation, 256-gradation, and 192-gradation, which have the same 10 fields and different weighting of the subfields SF1 to SF10.

Selection from among the subfields SF1 to SF10 allows a video to be expressed with gradations. For example, selection and display of the subfield SF1 results in the gradation value 1, selection and display of the subfield SF2 results in the gradation value 2, and selection and display of the subfields SF1 and SF2 results in the gradation value 3.

The sum of weights of all of the subfields SF1 to SF10 is the gradation number. In the six selectable gradation numbers, the subfield SF1 with the smallest weight (and the subfields SF2 to SF4) of each gradation number is the same in weight as the subfields SF1 with the smallest weight (and the subfields SF2 to SF4) of the other gradation numbers, while the subfield SF10 with the largest weight (and the subfields SF9 to SF7) of each gradation number is different in weight from the subfields SF10 with the largest weight (and the subfields SF9 to SF7) of the other gradation numbers.

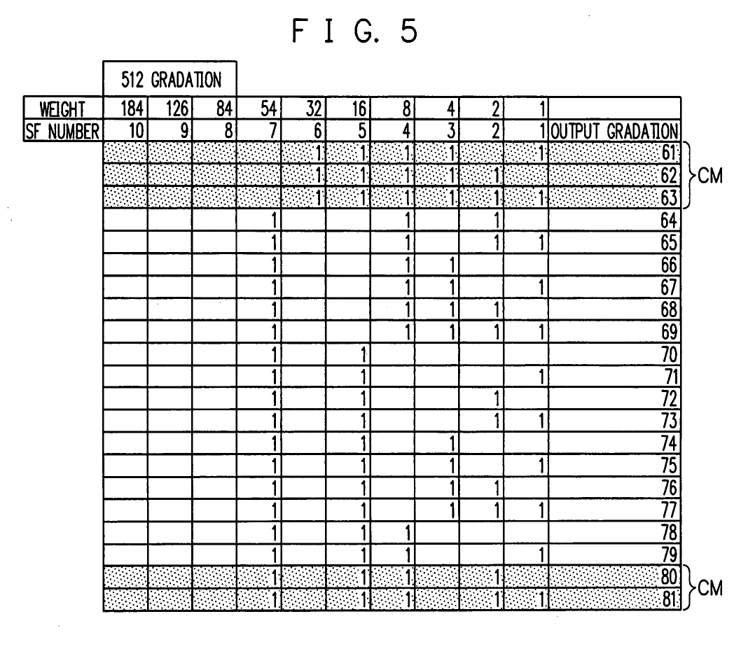

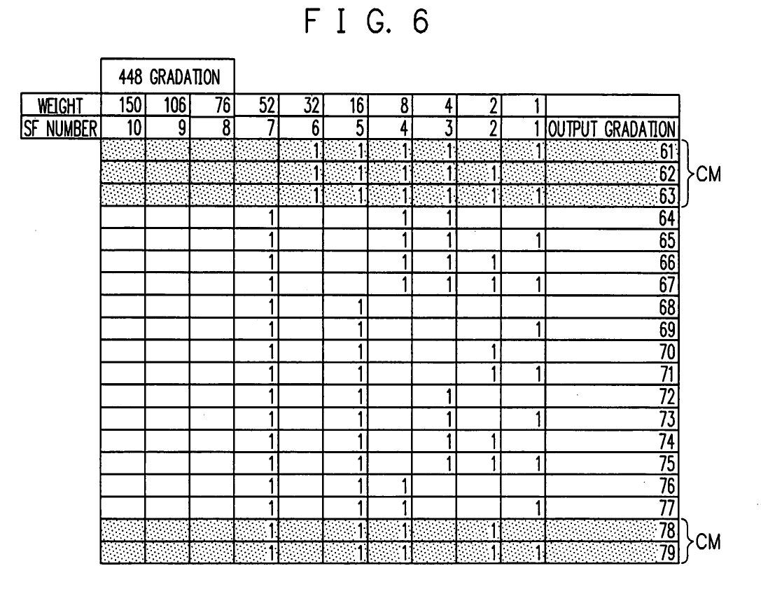

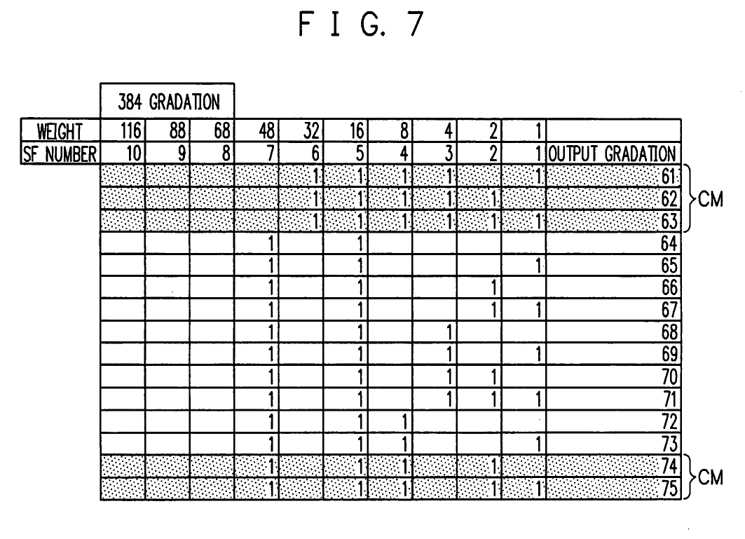

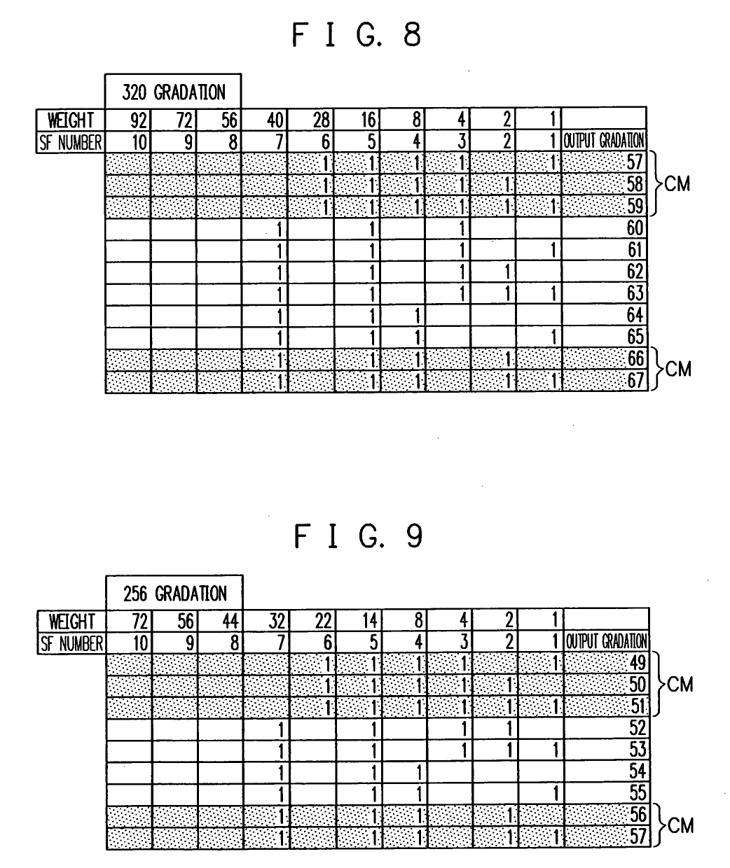

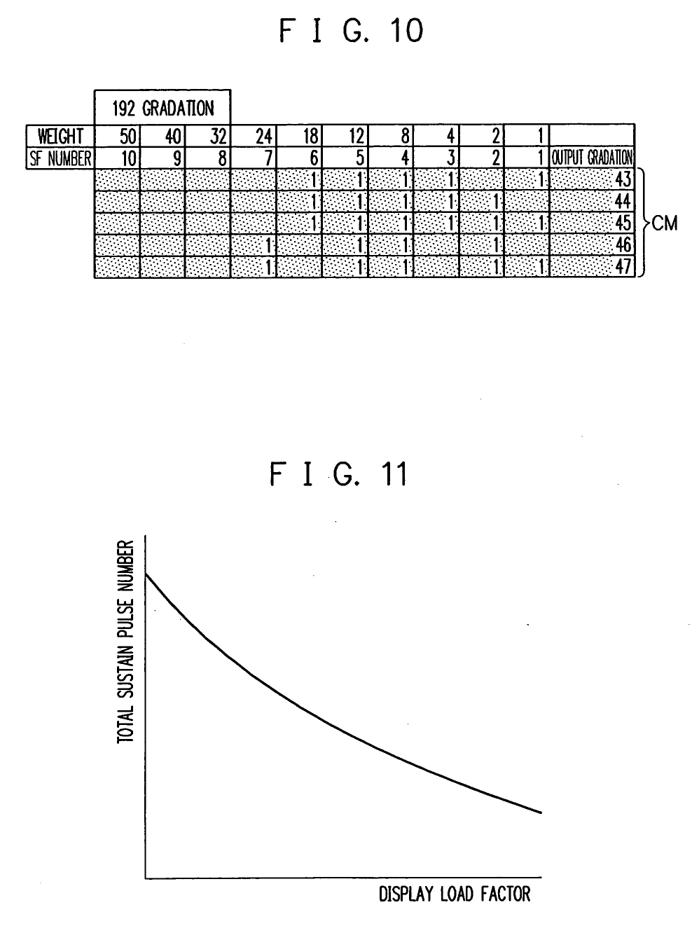

FIG. 5 shows the relation between selection patterns of the subfields SF1 to SF10 (subfield numbers 1 to 10) of the 512-gradation and output gradation values. FIG. 6 shows the relation between selection patterns of the subfields SF1 to SF10 of the 448-gradation and output gradation values. FIG. 7 shows the relation between selection patterns of the subfields SF1 to SF10 of the 384-gradation and output gradation values. FIG. 8 shows the relation between selection patterns of the subfields SF1 to SF10 of the 320-gradation and output gradation values. FIG. 9 shows the relation between selection patterns of the subfields SF1 to SF10 of the 256-gradation and output gradation values. FIG. 10 shows the relation between selection patterns of the subfields SF1 to SF10 of the 192-gradation and output gradation values.

In all of the six gradation numbers in FIG. 5 to FIG. 10, the same selection patterns CM are included. As the selection patterns CM, the output gradation values 43, 44, 45, 46, and 47 of the 192-gradation, the output gradation values 49, 50, 51, 56, and 57 of the 256-gradation, the output gradation values 57, 58, 59, 66, and 67 of the 320-gradation, the output gradation values 61, 62, 63, 74, and 75 of the 384-gradation, the output gradation values 61, 62, 63, 78, and 79 of the 448-gradation, and the output gradation values 61, 62, 63, 80, and 81 of the 512-gradation, are the same selection patterns.

More specifically, in the six selectable gradation numbers, all of the selection patterns of the subfields for expressing the gradation values of the 192-gradation being the minimum gradation number are included in the selection patterns of the subfields for expressing the gradation values of the other gradation numbers (the 512-gradation, 448-gradation, 384-gradation, 320-gradation, and 256-gradation).

Further, in this example, where the gradation number is increased from the 192-gradation, other selection patterns are inserted between the selection pattern “0000111111” and the selection pattern “0001011010”. All of the inserted selection patterns are patterns in each of which the seventh subfield SF7 is selected.

In other words, the selection patterns of the subfields for expressing the gradation values of the other gradation numbers (the 512-gradation, 448-gradation, 384-gradation, 320-gradation, and 256-gradation) are formed by inserting selection patterns of other subfields between the gradation value where a specific subfield (for example, the subfield SF7) is first selected and the preceding gradation value when the gradation values of the 192-gradation being the minimum gradation number are arranged in an ascending order.

It is not always necessary to store, in a memory, all of the subfield selection patterns for each of the six gradation numbers in FIG. 5 to FIG. 10. The subfield selection patterns of the 512-gradation being the maximum gradation number include all of the subfield selection patterns of the other gradation numbers, that is, the 448-gradation, the 384-gradation, the 320-gradation, the 256-gradation, and the 192-gradation. Therefore, it is only required to store, in the memory, the subfield selection patterns of the 512-gradation being the maximum gradation number and to store which subfield selection patterns among the subfield selection pattern of the maximum gradation number are not in use for the other gradation numbers. This can reduce the capacity to be stored in the memory.

The configuration in FIG. 1 will be described. An inverse γ conversion processing unit 101 receives a video signal in a digital form inputted thereto and subjects it to inverse y conversion. A one vertical scanning period (1V) delay unit 102 delays the video signal which has been subjected to the inverse γ conversion by one vertical scanning period. A gain control unit 103 gain-controls the output signal from the 1V delay unit 102 and outputs the gain-controlled signal to a gradation step conversion processing unit 104.

A sustain pulse number prediction unit 110 includes a gain control unit 111, an error diffusion processing unit 112, a subfield conversion processing unit 113, an every-subfield display load factor measurement unit 114, and a first sustain pulse number calculation processing unit 115 and predicts the number of sustain pulses.

The gain control unit 111 gain-controls the output signal from the inverse γ conversion processing unit 101 and outputs the gain-controlled signal to the error diffusion processing unit 112. The error diffusion processing unit 112 performs error diffusion processing so that the video signal has the minimum gradation number (the 192-gradation) of the above-described six gradation numbers. In other words, where an error in a decimal fraction part arises when the number of gradations of the inputted video signal is converted into the minimum gradation number, the error in the decimal fraction part is spatially diffused into adjacent pixels. The subfield conversion processing unit 113 performs subfield conversion according to the selection patterns of the minimum gradation number (the 192-gradation) in FIG. 10 to determine the selection patterns of the subfields.

The every-subfield display load factor measurement unit 114 calculates the display load factor for every subfield. The display load factor is detected based on the number of emitting pixels and the gradation values of the emitting pixels. For example, when all of the pixels of one field image are displayed at the maximum gradation value, the display load factor is 10%. When all of the pixels of one field image are displayed at half the maximum gradation value, the display load factor is 50%. When only half (50%) of the pixels of one field image are displayed at the maximum gradation value, the display load factor is also 50%.

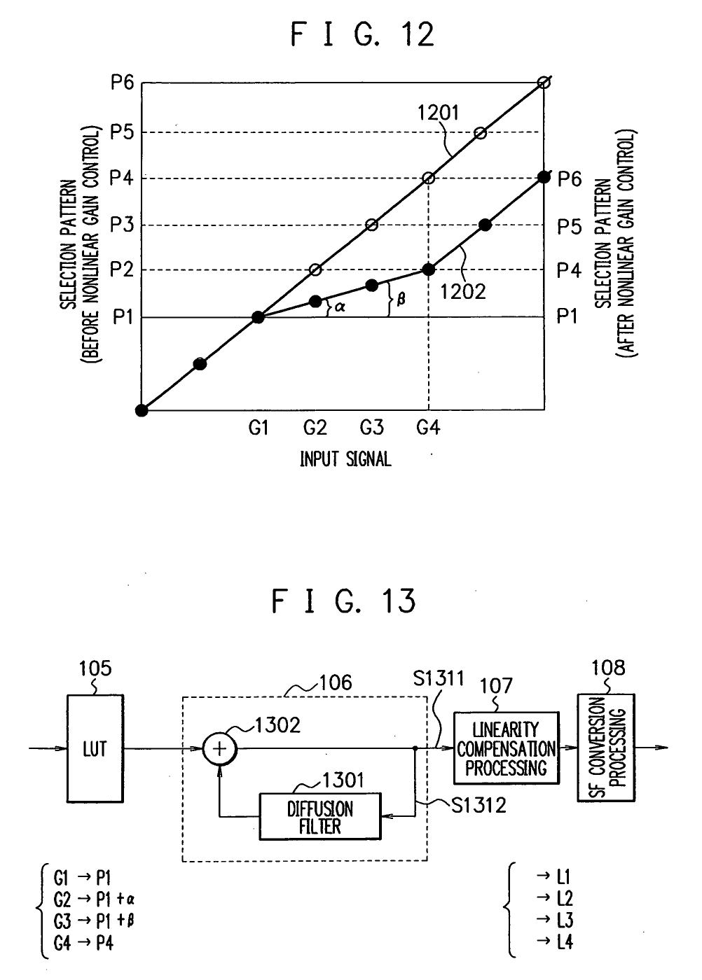

The first sustain pulse number calculation processing unit 115 calculates the total number of sustain pulses in one field by power constant control and load correction processing according to the display load factor. In the power constant control, as shown in FIG. 11, the total number of sustain pulses in one filed is controlled according to the display load factor in one field. Irrespective of the display load factor, where the total number of sustain pulses in one field is fixed, the power increases with an increase in the display load factor, resulting in increased heat quantity. Hence, the first sustain pulse number calculation processing unit 115 calculates to decrease the total number of sustain pulses in one field when the display load factor in one field is large for the power constant control.

The aforementioned load correction processing will be described. The effective brightness of the display in each subfield is determined by the luminance by sustain discharge and the number of sustain pulses (the sustain discharge period). The number of sustain pulses in each subfield is the proportion of a predetermined weight. If the display load factors of subfields are the same, the luminances by sustain discharges are also the same, so that brightnesses of displays are in the same ratio as that of the numbers of sustain pulses. However, when the display load factors of subfields are different, the luminance by sustain discharge is different for every subfield, so that brightnesses of displays by the subfields are not in the predetermined ratio. If such a thing happens, the gradation values displayed by combination of subfields are not accurately displayed. In an extreme case, there is a problem of brightness inversion occurring between gradation values. To solve this problem, the number of sustain pulses of each subfield is corrected according to the display load factor of each subfield. The first sustain pulse number calculation processing unit 115 calculates the total number of sustain pulses in one field after the correction.

A gradation number selection unit 116 selects a gradation number being the sum of the weights of all of the subfields according to the total number of sustain pulses calculated in the first sustain pulse number calculation processing unit 115. For example, the gradation number selection unit 116 selects the most suitable gradation number from among the above-described six gradation numbers. The gradation number selection unit 116 selects a larger gradation number for the larger total number of sustain pulses. What is obtained by dividing the total number of sustain pulses by the gradation number is the gradation step, and the gradation step preferably has a fixed value.

When the gradation number which is the value obtained by dividing the calculated total number of sustain pulses by a predetermined number of gradation steps lies between a plurality of selectable gradation numbers, the gradation number selection unit 116 selects either of preceding and subsequent selectable gradation numbers to the gradation number being the aforementioned dividing value. In this event, the gradation number selection unit 116 selects, from among the aforementioned preceding and subsequent selectable gradation numbers, the gradation number having the number of sustain pulses of the subfield with a small weight closer to that of the gradation number selected at the preceding time.

The gradation step conversion processing unit 104 converts the video signal outputted from the gain control unit 103 to one having the aforementioned selected gradation number. Specifically, the gradation step conversion processing unit 104 performs gradation number conversion by dividing the dynamic range of the input video signal by the aforementioned selected gradation number into equal steps. For example, when converting a 256-gradation signal to a 512-gradation signal, the gradation step conversion processing unit 104 performs calculation of 256-512. In this case, 256÷512□0.5, so that the video signal is outputted, by a step width of 0.5 gradation, to a nonlinear gain control processing unit 105 at the subsequent stage.

The nonlinear gain control processing unit 105 and an error diffusion processing unit 106, similarly to the above-described gain control unit 111 and error diffusion processing unit 112, spatially diffuse the error in the decimal fraction due to the gradation number conversion as well as perform dynamic false contour prevention processing. The subfield selection pattern of a specific gradation value together with the subfield patterns of pixels adjacent thereto appears, to the human eye, as if a false contour of a large gradation value exists in the moving image. This phenomenon is the dynamic false contour. To prevent the dynamic false contour, the nonlinear gain control processing unit 105 and error diffusion processing unit 106 perform the error diffusion processing by replacing the specific gradation value with another gradation value to prevent use of the specific gradation value.

The nonlinear gain control processing unit 105 performs gain processing suitable for the aforementioned selected gradation number to maintain the linearity of the input video signal and the output signal as well as performs nonlinear gain processing to generate a new gradation value by performing error diffusion processing for the gradation value which is prone to cause the dynamic false contour. The error diffusion processing unit 106 can reduce the dynamic false contour by performing the error diffusion processing for the output signal from the nonlinear gain control processing unit 105. Details of the nonlinear gain control processing unit 105 and the error diffusion processing unit 106 will be described later with reference to FIG. 12 to FIG. 14.

A linearity compensation processing unit 107 converts the gradation value to a subfield selection pattern according to the selection pattern of the subfields corresponding to the selected gradation number. A subfield conversion processing unit 108 performs subfield conversion processing for the output signal from the linearity compensation processing unit 107 to convert the signal to subfield data. The address control unit 121 generates, according to the subfield data, a voltage for the address electrode Aj for selecting a subfield during which each pixel lights.

A second sustain pulse number calculation processing unit 117 corrects, as necessary, the total number of sustain pulses calculated by the first sustain pulse number calculation processing unit 115 and outputs the total number of sustain pulses. That correction is correction to decrease the total number of sustain pulses so as to keep heat at a fixed temperature or lower or to reduce the power by external operation.

A sustain pulse signal generation unit 118 divides the total number of sustain pulses to correspond to the weight ratio among the subfields of the aforementioned selected gradation number, thereby generating a sustain pulse signal for display. The X electrode control unit 122 and the Y electrode control unit 123 generate voltages for the X electrode Xi and the Y electrode Yi according to the sustain pulse signal. The display cell selected by the address electrode Aj sustain-discharges between the X electrode Xi and the Y electrode Yi to emit light.

FIG. 13 is a diagram showing a configuration example of the nonlinear gain control processing unit 105 and the error diffusion processing unit 106. The nonlinear gain control processing unit 105, which is composed of a look-up table, conducts nonlinear gain control shown in FIG. 12 to prevent the dynamic false contour. On a characteristic 1201 before the nonlinear gain control, an input signal G1 displays a luminance L1 by a subfield selection pattern (hereinafter referred to as a selection pattern) P1, an input signal G2 displays a luminance L2 by a selection pattern P2, an input signal G3 displays a luminance L3 by a selection pattern P3, and an input signal G4 displays a luminance L4 by a selection pattern P4. In this event, where the selection patterns P1 and P2 are selection patterns that greatly vary the centers of light emission, the dynamic false contours appear. To reduce the dynamic false contour, it is only required to perform the diffusion processing between the selection patterns where the dynamic false contours appear. Hence, in consideration of the magnitude of movement, the luminances L2 and L3 are displayed by diffusing the luminances L1 and L4 instead of using the selection patterns P2 and P3. To realize this display, the nonlinear gain control processing unit 105 converts, as shown by the characteristic 1202, the input signal G1 to the selection pattern P1, the input signal G2 to P1+α, the input signal G3 to P1+β, and the input signal G4 to P4, where 0<α<β<1.

The error diffusion processing unit 106 includes a diffusion filter 1301 and an adding unit 1302. The adding unit 1302 adds the output signal from the nonlinear gain control processing unit 105 and the output signal from the diffusion filter 1301 and outputs them. The output includes an integer part S1311 and a decimal fraction part S1312. The integer part S1311 is outputted to the linearity compensation processing unit 107. The diffusion filter 1301 can filter the decimal fraction part S1312 to spatially diffuse the error in the decimal fraction part. As a result, the selection pattern P1 displays the luminance L1, the selection pattern P1+α displays the luminance L2, the selection pattern P1+β displays the luminance L3, and the selection pattern P4 displays the luminance L4.

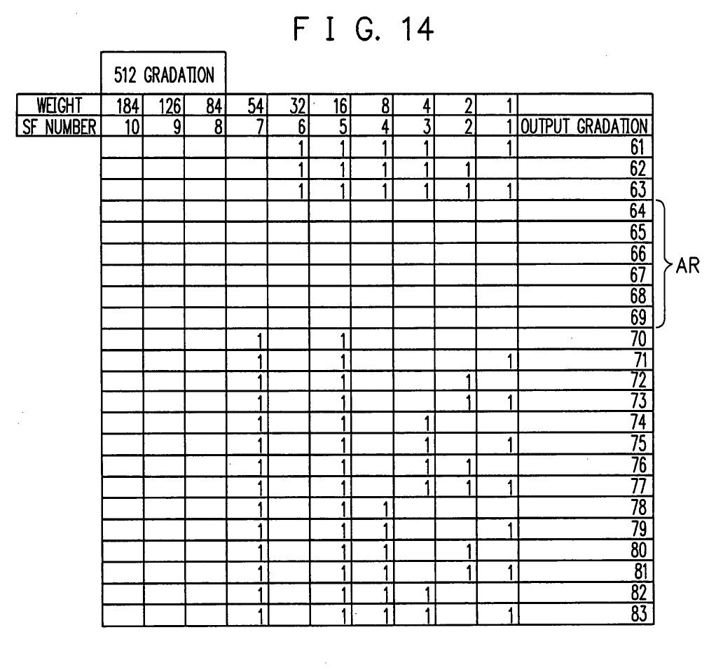

FIG. 14 is a list showing an example where the error diffusion processing unit 106 generates gradation values by error diffusion. For example, in the 512-gradation, the error diffusion processing unit 106 modifies the selection patterns in FIG. 5 into selection patterns in FIG. 14. An example will be illustrated in which preceding and subsequent gradation values to the gradation value where a larger subfield (for example, the seventh subfield SF7) is first lights are expressed by diffusion processing in a subfield pattern of a larger gradation number such as in the 512-gradation. The dynamic false contour is more prone to appear in the selection pattern of a gradation value 70 than in the selection pattern of a gradation value 63 because the heavy subfield SF7 lights which has not lighted up to that time. For this reason, six gradation values AR, that is, gradation values 64, 65, 66, 67, 68, and 69 are inserted between the aforementioned two gradation values and subjected to the error diffusion processing by the selection pattern of the gradation value 63 and the selection pattern of the gradation value 70 for display. In other words, the gradation values 64 to 69 are replaced with the gradation value 63 or 70, the differentials therebetween are spatially diffused.

The error diffusion processing unit 106 performs the error diffusion processing by replacing a specific gradation value with another gradation value to prevent use of the specific gradation value in gradation values after the gradation number conversion. The aforementioned specific gradation value includes the gradation value (for example, the gradation value 64 in FIG. 5) where the specific subfield (for example, the seventh subfield SF7) is first selected when gradation values are arranged in an ascending order. Besides, there are a larger number of the aforementioned specific gradation values on the higher gradation value side, and there are no or a smaller number of the aforementioned specific gradation values on the lower gradation value side.

### Second Embodiment

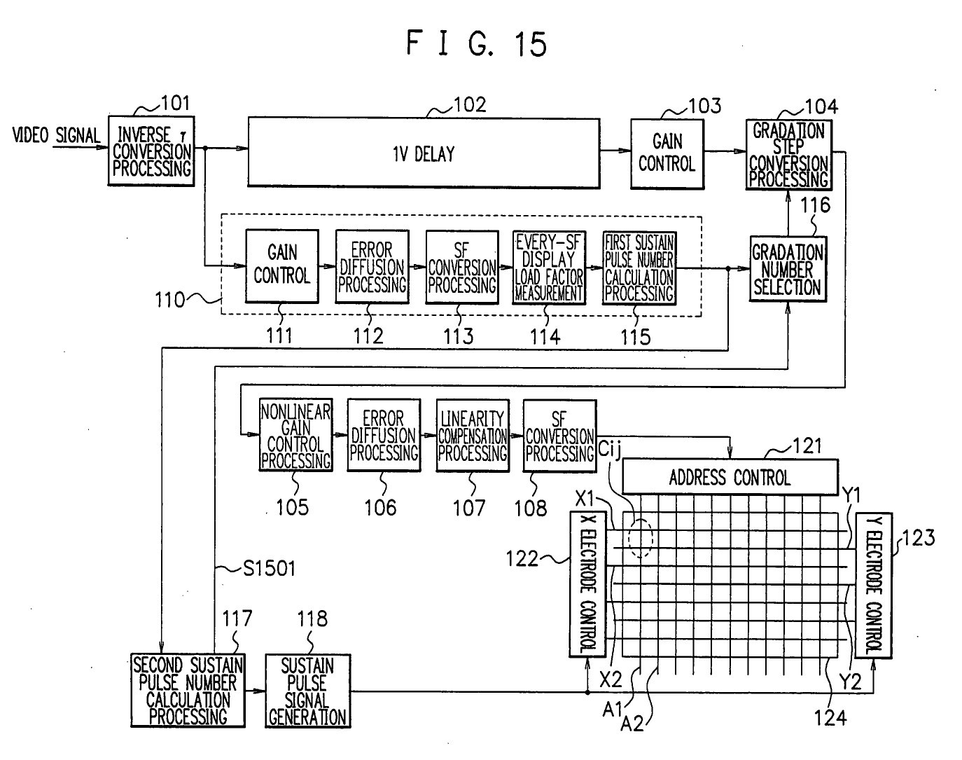

FIG. 15 is a diagram showing a configuration example of a plasma display device according to a second embodiment of the present invention. FIG. 15 is different from FIG. 1 in that a second sustain pulse number calculation processing unit 117 outputs a minimum gradation number selection signal S1501 to a gradation number selection unit 116 according to the calculation result. The gradation number selection unit 116, when receiving the minimum gradation number selection signal S1501 inputted thereto, selects a minimum gradation number. The second sustain pulse number calculation processing unit 117 may perform processing to vary the number of sustain pulses such as control to decrease the number of sustain pulses and reduction of the power by external operation in order to keep the heat of the plasma display panel, circuit components and so on at a fixed temperature or lower. In this case, the number of sustain pulses may be greatly different from the number of sustain pulses predicted by a sustain pulse number prediction unit 110, thus exerting an influence on the image quality. To prevent such an influence, when greatly varying the number of sustain pulses, the second sustain pulse number calculation processing unit 117 switches the number of gradations to the minimum gradation number in this field or the subsequent field and later fields to prevent the deterioration in the image quality.

As described above, according to the first and second embodiments, the first characteristic is to measure the display load factor in one field of the input signal using the minimum gradation number, perform a predetermined calculation, and select a gradation number using the result of calculating the total number of sustain pulses. This allows an appropriate total number of sustain pulses to be determined according to the display load factor and an appropriate gradation number to be selected according to the total number of sustain pulses. This enables prevention of flicker when the display load factor is large and prevention of insufficient expressiveness at a low gradation value part when the display load factor is small. In addition, it is also possible to prevent the flicker when the total number of sustain pulses is too large with respect to the gradation number and to prevent noise due to insufficient gradations when the total number of sustain pulses is too small with respect to the gradation number.

The second characteristic is that the subfield selection patterns associated with the minimum gradation number are included in the subfield selection patterns of the other gradation numbers, so that increase in size of the memory to store the subfield selection patterns is suppressed as much as possible. The case of a method including a look-up table of the selection patterns for each average luminance level (APL) incurs a significant increase in size of memory. In this embodiment, however, the look-up tables to be stored in the memory are only those for the selection patterns for the maximum gradation number, and only the selection patterns not for use in the look-up tables need to be stored in the memory for the switch of the gradation number.

The third characteristic is that where the subfield selection patterns are arranged such that the gradation values are in an ascending order, the subfield selection patterns of the other gradation numbers different from the selection patterns of the minimum gradation number are inserted between the gradation value where a subfield with a large weight in the subfield selection pattern of the minimum gradation number is first selected after continuous non-selection and the preceding gradation value, thereby solving level difference in luminance due to increase in the difference in weight between the subfields and reducing as much as possible occurrence of the dynamic false contour.

The fourth characteristic is that in the selection patterns of a large gradation number, preceding and subsequent gradation values to the gradation value where a subfield with a larger weight is first selected are expressed by diffusion processing. This further reduces the dynamic false contour which cannot be reduced by the third characteristic.

The fifth characteristic is that a larger number of gradation values are expressed by diffusion processing on the higher gradation value side, and no or a smaller number of gradation values are expressed by diffusion processing on the lower gradation value side. The purpose of expressing a larger number of gradation values by diffusion processing on the higher gradation value side is to reduce the dynamic false contour as described in the fourth characteristic, and the purpose of expressing no or a smaller number of gradation values by diffusion processing on the lower gradation value side is to display the low gradation value part by lighting pixels in a high density. To reduce the dynamic false contour in all of the gradation values, gradation values for which diffusion processing is performed are allowed even on the low gradation value side. Therefore, the weighting of the subfields on the lower side is not always limited to binary numbers.

It is possible to determine an appropriate number of sustain pulses according to the display load factor and to select an appropriate gradation number according to the total number of sustain pulses. It is also possible to prevent flicker when the display load factor is large and to prevent insufficient expressiveness at a low gradation value part when the display load factor is small. Further, it is also possible to prevent flicker when the total number of sustain pulses is too large with respect to the gradation number and to prevent noise due to insufficient gradations when the total number of sustain pulses is too small with respect to the gradation number.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device expressing a video with gradations by controlling lighting of each of a plurality of subfields forming one field, each of the subfields having a weighted luminance, comprising:
a load factor calculation unit calculating a display load factor of an input video signal; and
a change and control unit changing and controlling a total number of sustain pulses in the one field according to the display load factor, and changing and controlling a number of expressible gradations.

2. The plasma display device according to claim 1, wherein even when the number of gradations is changed by said change and control unit, the number of sustain pulses in a subfield with a smallest luminance weight is substantially fixed.

3. The plasma display device according to claim 1, wherein even when the number of gradations is changed by said change and control unit, a number of the plurality of subfields constituting the one field is substantially fixed.

4. The plasma display device according to claim 1, wherein in a plurality of gradation numbers changed and controlled by said change and control unit, a subfield with a smallest luminance weight of each of the gradation numbers is the same in luminance weight as subfields with smallest luminance weights of the other gradation numbers, and a subfield with a largest luminance weight of each of the gradation numbers is different in luminance weight from subfields with largest luminance weights of the other gradation numbers.

5. The plasma display device according to claim 1, wherein in a plurality of gradation numbers changed and controlled by said change and control unit, selection patterns of subfields for expressing gradation values of a minimum gradation number are included in selection patterns of subfields for expressing gradation values of the other gradation numbers.

6. The plasma display device according to claim 1, wherein selection patterns of the subfields for expressing gradation values of the other gradation numbers are formed by inserting selection patterns of other subfields between a gradation value wherein a specific subfield is first selected and a preceding gradation value when the gradation values of a minimum gradation number are arranged in an ascending order.

7. A method of controlling a plasma display device expressing a video with gradations by controlling lighting of each of a plurality of subfields forming one field, each of the subfields having a weighted luminance, comprising the steps of:
calculating a display load factor of an input video signal; and
changing and controlling a total number of sustain pulses in the one field according to the display load factor, and changing and controlling a number of expressible gradations.

8. The method of controlling a plasma display device according to claim 7, wherein even when the number of gradations is changed by said change and control, the number of sustain pulses in a subfield with a smallest luminance weight is substantially fixed.

9. The method of controlling a plasma display device according to claim 7, wherein even when the number of gradations is changed by said change and control, a number of the plurality of subfields constituting the one field is substantially fixed.

10. The method of controlling a plasma display device according to claim 7, wherein in a plurality of gradation numbers changed and controlled by said change and control, a subfield with a smallest luminance weight of each of the gradation numbers is the same in luminance weight as subfields with smallest luminance weights of the other gradation numbers, and a subfield with a largest luminance weight of each of the gradation numbers is different in luminance weight from subfields with largest luminance weights of the other gradation numbers.

11. The method of controlling a plasma display device according to claim 7, wherein in a plurality of gradation numbers changed and controlled by said change and control, selection patterns of subfields for expressing gradation values of a minimum gradation number are included in selection patterns of subfields for expressing gradation values of the other gradation numbers.

12. The method of controlling a plasma display device according to claim 7, wherein selection patterns of the subfields for expressing gradation values of the other gradation numbers are formed by inserting selection patterns of other subfields between a gradation value where a specific subfield is first selected and a preceding gradation value when the gradation values of a minimum gradation number are arranged in an ascending order.
